(19) United States
(12) Patent Application Publication
(10) Pub. No.: US 2019/0321952 A1
(43) Pub. Date: Oct. 24, 2019

(54) TOOL FOR REMOVING HEADREST SUPPORTS

(71) Applicant: TOYOTA BOSHOKU KABUSHIKI KAISHA, Aichi-ken (JP)

(72) Inventor: Hiroshi OKAMOTO, Aichi-ken (JP)

(73) Assignee: TOYOTA BOSHOKU KABUSHIKI KAISHA, Aichi-ken (JP)

(21) Appl. No.: 16/475,339

(22) PCT Filed: Jul. 10, 2018
(86) PCT No.: PCT/JP2018/026026

§ 371 Date: Jul. 1, 2019

(30) Foreign Application Priority Data
Jul. 11, 2017 (JP) 2017-135342

(51) Int. Cl. B25B 27/14; B60N 2/897; B60N 2/882

(52) U.S. Cl. CPC B25B 27/14; B60N 2/882; B60N 2/897

(57) ABSTRACT

A headrest support includes a head portion, a body portion, and a through hole formed inside. An elastically deformable projection is formed to extend from a lower edge of an opening provided in an outer peripheral surface of the body portion. The headrest support is inserted into a holder and supported while the projection is engaged in a locking hole. The removal tool includes a shaft portion and a handle portion. A vertical wall portion is formed at a leading end of the shaft portion, wherein the vertical wall portion is configured to enter into a side gap between a peripheral edge of the opening and the projection when the shaft portion is inserted into the through hole, and wherein the vertical wall portion is configured to be able to deform the projection toward an inside of the through hole when the shaft portion is rotated.

### CROSS-REFERENCE TO RELATED APPLICATIONS

The present application is a U.S. National Phase entry of, and claims priority to, PCT Application No. PCT/JP2018/026026, filed Jul. 10, 2018 which claims priority to Japanese Patent Application No. 2017-1355342, filed Jul. 11, 2017, both of which are incorporated herein by reference in their entireties for all purposes.

### BACKGROUND

The present disclosure relates to a system and a tool for removing headrest supports.

Typically, a vehicle seat such as a seat for an automobile is provided with a headrest for supporting a head of a seated occupant. The headrest is provided with a pair of stays extending downward. The headrest is supported to a seatback by inserting each of these stays into a pair of headrest supports that are fixed inside of the seatback. Specifically, as described in a Japanese Laid-Open Patent Publication No. 11-89665, each of the headrest supports includes and is integrally formed with a flange-like head portion at an upper end and body portion extending downward from the head portion, wherein a vertically extending through hole for inserting the stay therein is formed with each of the headrest supports. Further, each of the headrest supports is inserted and held in each of a pair of tubular holders fixed to a frame inside the seatback. A lateral surface of the body portion of each of the headrest supports is provided with a claw extending outwardly. As the headrest supports are inserted into the holders, the claws engage in locking holes to prevent the headrest support from detaching from the holders.

According to a technology described in the Japanese Laid-Open Patent Publication No. 11-89665, the claws come to be in an engaged state into the locking holes when the headrest supports are inserted into the holders. When the headrest supports are to be-removed from the seatback in this state, it is necessary to remove a back pad and/or a back cover, which cover a back frame, from the back frame. This is because the claws extending in the locking holes within the seatback must be pressed in a direction toward the inside the holder in order to disengage the claws engaged in the locking holes from the locking holes. However, if the holders are not exposed to the outside, such operation cannot be performed. For example, when damage or the like is found at a head portion of the headrest support while the headrest support is attached to the seatback, the headrest support may need to be replaced. In this case, the number of operation steps may be increased because the back pad and/or the back cover must be removed from the back frame.

In view of these facts, a problem to be solved by the present disclosure is to provide a tool for removing headrest supports from a seatback without removing a back pad and/or a back cover from an outer side of a seatback.

### BRIEF SUMMARY

According to one aspect of the present disclosure, a tool for removing a headrest support serves to remove a headrest support from a seatback. The headrest support includes a head portion and a body portion and is formed with a through hole into which a headrest stay is inserted. At least one opening is formed on an outer peripheral surface of the body portion. The headrest support has an elastically deformable projection extending upward from a lower edge of the opening to be widened toward an outer peripheral side of the body portion. The headrest support is inserted into a holder to be supported by the holder, wherein the holder is fixed at a frame of the seatback and is formed in a hollow tubular shape, while the projection is engaged in the locking hole to prevent the headrest support from being removed from the holder. The tool for removing the headrest support includes a shaft portion, which is inserted into the through hole from the head portion side, and a handle portion fixed on the shaft portion. The tool further includes an insertion piece at an end of the shaft portion that is at an opposite end to the handle portion, wherein the insertion piece is configured to be entered a gap between a peripheral edge of the opening and the projection when the shaft portion is inserted into the through hole from the head portion side, and the insertion piece is configured to be able to deform the projection toward an inside of the through hole, when the shaft portion is rotated.

Therefore, the insertion piece is allowed to enter the gap between the peripheral edge of the opening and the projection when the shaft portion of the tool is inserted into the through hole of the headrest support, while the headrest support is still attached to the seatback. Subsequently, the shaft portion is rotated by operating the handle portion in this state. As a result, the projection is deformed toward the inside of the through hole by the insertion piece to be disengaged from the peripheral edge of the locking hole of the holder. In this way, it is possible to remove the headrest support from the seatback without removing a back pad or a back cover from the outside of the seatback.

### BRIEF DESCRIPTION OF THE DRAWINGS

FIG. 1 is an exploded perspective view of a headrest, headrest supports, and holders.

FIG. 2 is a side view of the headrest support.

FIG. 3 is a cross-sectional view taken along a line III-III in FIG. 2.

FIG. 4 is a front view of a tool for removing the headrest support according to one exemplary embodiment of the present disclosure.

FIG. 5 is a plan view of the tool for removing the headrest support according to the above exemplary embodiment.

FIG. 6 is a side view of the tool for removing the headrest support according to the above exemplary embodiment.

FIG. 7 is a view illustrating a removal of the headrest support utilizing the tool for removing the headrest support according to the above exemplary embodiment.

FIG. 8 is a view illustrating the removal of the headrest support utilizing the tool for removing the headrest support according to the above exemplary embodiment.

FIG. 9 is a view illustrating the removal of the headrest support utilizing the tool for removing the headrest support according to the above exemplary embodiment.

FIG. 10 is a view illustrating the removal of the headrest support utilizing the tool for removing the headrest support according to the above exemplary embodiment.

FIG. 11 is a front view of the tool for removing the headrest support according to another exemplary embodiment of the present disclosure.

FIG. 12 is a plan view of the tool for removing the headrest support according to the above another exemplary embodiment of the present exemplary embodiment.

FIG. 13 is a side view of the tool for removing the headrest support according to the above another exemplary embodiment.

### DETAILED DESCRIPTION

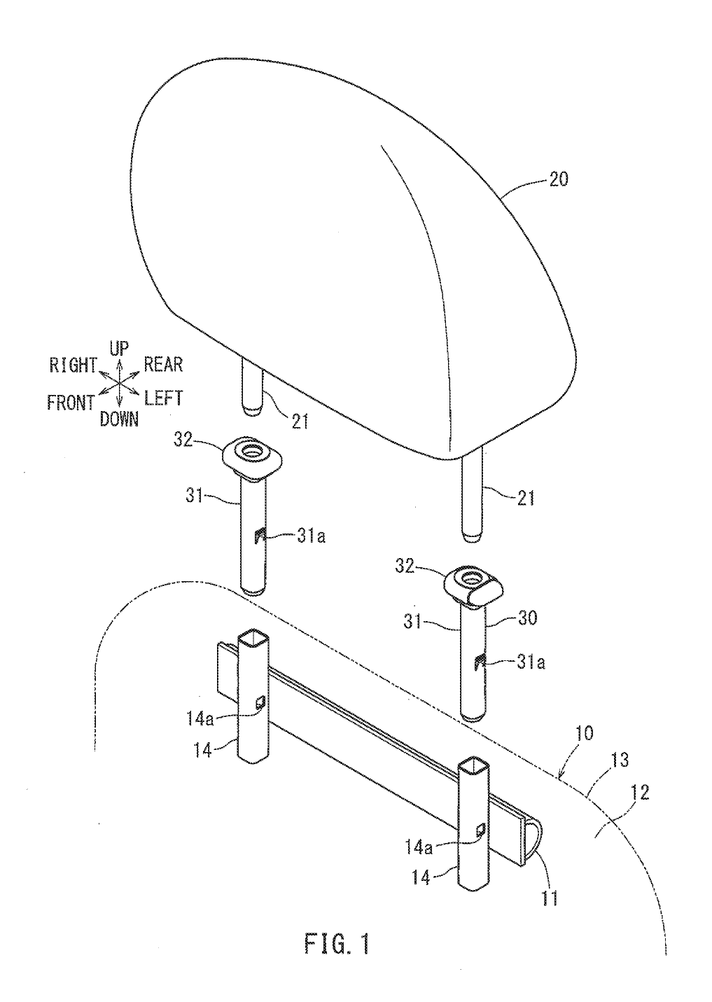

Headrest supports 30 to be removed from a seatback utilizing a tool for removing a headrest support according to one exemplary embodiment of the present disclosure will be described in accordance with FIGS. 1 to 3. Arrows in each Figure indicate respective directions of a seatback 10 while the headrest supports 30 are attached to the seatback 10. In the following description, the description regarding the directions will be described on a basis of these directions.

FIG. 1 illustrates an exploded perspective view of an upper portion of the seatback 10 of an automobile seat, a headrest 20, and the headrest supports 30. The automobile seat includes a seat cushion to be sat on by a passenger, a seatback 10 serving as a backrest for the passenger, and a headrest 20 for supporting a head of the passenger. The seat cushion will not be described since it has a well-known configuration, while the seatback 10 and the headrest supports 30 for attaching the headrest 20 to the seatback 10 will be described.

As shown in FIG. 1, the seatback 10 is configured such that a back pad 12 serving as a cushion material covers a back frame 11 serving as a skeleton, and a back cover 13 serving as a skin material covers them. Two hollow tubular holders 14 are fixed on an upper portion of the back frame 11. Each of the headrest supports 30 is inserted into and attached to each of the two holders 14. The headrest 20 is supported to the back frame 11 by two headrest stays 21 extending downward from the headrest 20. The headrest stays 21 are inserted in each of the headrest supports 30.

Each holder 14 is formed to have a quadrangular tubular form in a cross-section and is fixed at the upper portion of the back frame 11 by welding such that its axis arranged to extend in a vertical direction. An locking hole 14a as a rectangular opening with its long side determined as a vertical direction is formed in the substantially vertical center of left and right sides of each holder 14.

Each headrest support 30 includes a body portion 31 and a head portion 32, wherein the body portion 31 has a cross-section to be inserted into an inner tubular portion of the holder 14. The cross-section of the body portion 31 is formed in a substantially quadrangular tubular shape. The head portion 32 is formed as a flange-like large diameter portion at an upper end side of the body portion 31. The body portion 31 and the head portion 32 are integrally formed of resin.

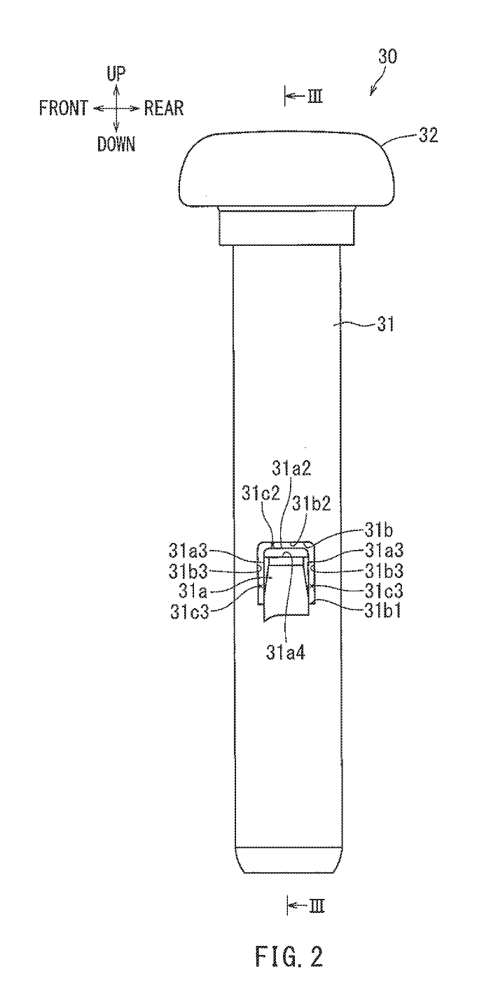

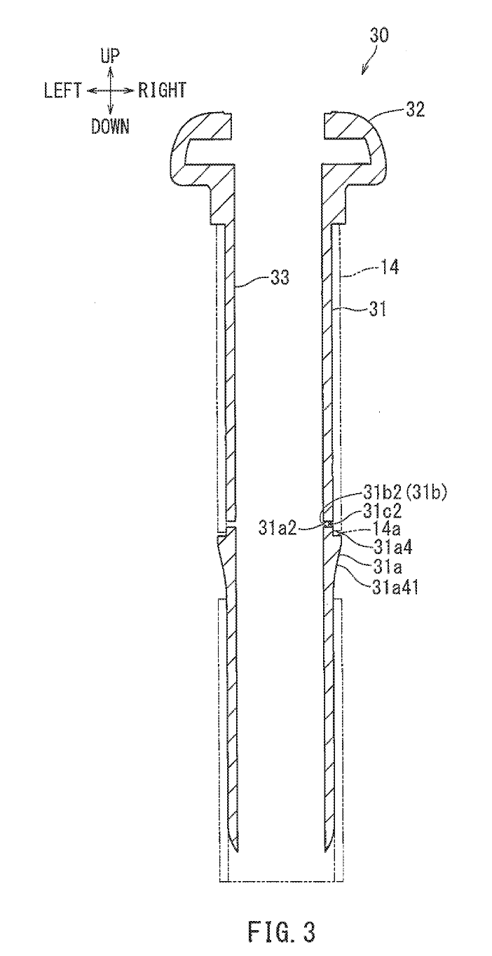

As shown in FIGS. 1 to 3, the body portion 31 and the head portion 32 of each headrest support 30 are provided with a through hole 33 inside thereof, wherein the through hole 33 has a circular cross-section to allow the headrest stay 21 to be inserted. The body portion 31 of each headrest support 30 is provided with projections 31a at substantially the vertical center of the left and right sides thereof and projecting outwardly. When the headrest support 30 is inserted into an inner tubular portion of the holder 14, the projections 31a of the headrest support 30 engage in the locking holes 14a so that the headrest support 30 is held so as to be prevented from being removed from the holder 14. Specifically, as shown in FIGS. 2 and 3, the body portion 31 is provided with rectangular openings 31b at substantially the vertical center of left and right sides on an outer peripheral surface thereof, wherein the openings 31b pass through the body portion 31 in left and right direction and oppose each other. The projections 31a extend upward from a lower edge 31b1 of the opening 31b to cover a center area of the opening 31b. The projections 31a are formed such that an upper end 31a2 side is elastically deformable in a radial direction of the body portion 31, with respect to the lower edge 31b1 of the opening 31b. An upper gap 31c2 is formed between the upper end 31a2 of the projection 31a and an upper edge 31b2 of the opening 31b. A side gap 31c3 is formed between a side 31a3 of the projection 31a and a side edge 31b3 of the opening 31b. An engagement portion 31a4 is formed slightly below the upper end 31a2 of the projection 31a, wherein the engagement portion 31a4 extends in an outer peripheral direction beyond an outer surface of the body portion 31. An outer peripheral surface of the engagement portion 31a4 is formed with an inclined surface 31a41 which gradually approaches the outer surface of the body portion 31 as it extends downward. When the headrest support 30 is inserted into the inner tubular portion of the holder 14, an outer peripheral end of the engagement portion 31a4 abuts the inner tubular portion of the holder 14 so that the engagement portion 31a4 is bent in a direction towards the through hole 33. Subsequently, when the engagement portion 31a4 of the projection 31a passes the upper edge of the locking hole 14a at the holder 14, the projection 31a is restored to the original state so that the engagement portion 31a4 engages the upper edge of the locking hole 14a. In this way, the headrest supports 30 are held so as not to exit the holders 14.

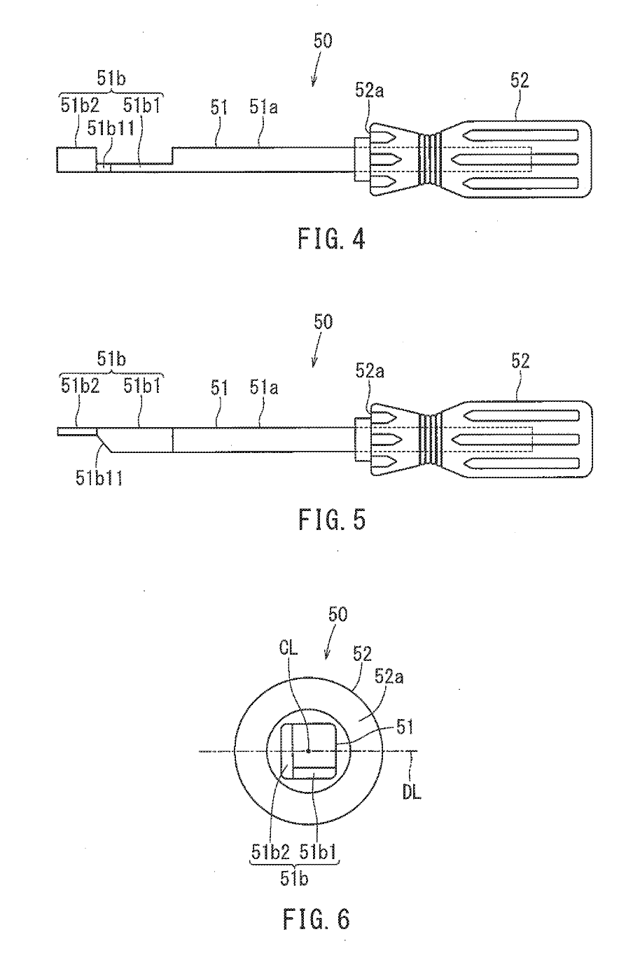

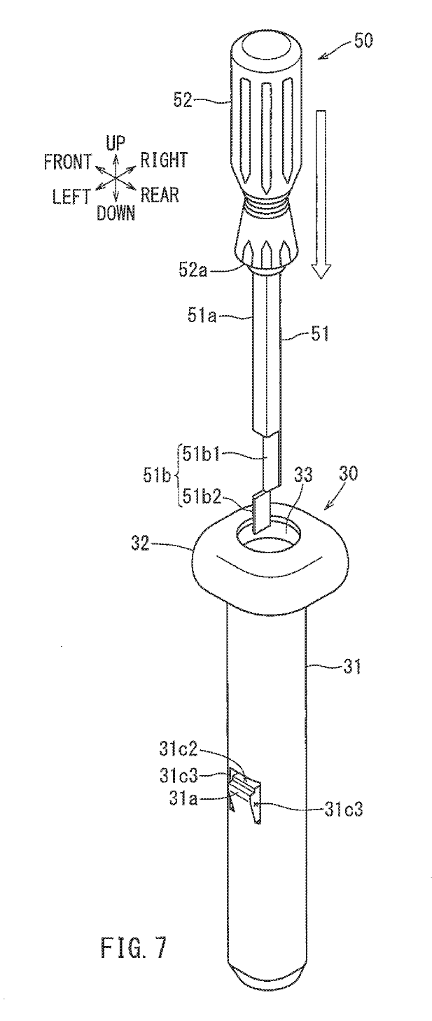

As shown in FIG. 4 and FIG. 6, the removal tool 50 includes a shaft portion 51 and a handle portion 52 having a larger diameter than that of the shaft portion 51. The handle portion 52 is coaxially fixed to the shaft portion 51. The shaft portion 51 on the side of the handle portion 52 is formed as a main body portion 51a having a rectangular columnar cross-section, while the opposite side of the handle portion 52 is formed as an engagement portion 51b configured to engage the projection 31a of the headrest support 30. The engagement portion 51b includes a lateral wall portion 51b1 with a substantially rectangular plate shape and a vertical wall portion 51b2 with a substantially rectangular plate shape. The lateral wall portion 51b1 extends from one lateral side of the main body portion 51a toward the leading end. The vertical wall portion 51b2 extends from one side of a shorter leading end of the lateral wall portion 51b1 toward the leading end, the vertical wall portion 51b2 positioned vertically with respect to the lateral wall portion 51b1. The vertical wall portion 51b2 has a longer side length, the longer side length corresponding to an axial length of the shaft portion 51. The longer side length may be slightly shorter than a vertical length of the side gap 31c3 of the headrest support 30. A shorter side length of the vertical wall portion 51b2 may be substantially as large as a radius of the through hole 33 of the headrest support 30 (see FIG. 7). A thickness of the vertical wall portion 51b2 may be slightly thinner than a width of the side gap 31c3 of the headrest support 30 in the front-rear direction. Therefore, the vertical wall portion 51b2 is formed to be able to be inserted into the side gap 31c3 of the headrest support 30. The lateral wall portion 51b1 has a longer side length, the longer side length corresponding to the axial length of the shaft portion 51. The longer side length of the lateral wall portion 51b1 has about twice the length of the longer side of the vertical wall portion 51b2. A shorter side length of the lateral wall portion 51b1 is formed to be substantially equal to the shorter side length of the vertical wall portion 51b2. A thickness of the lateral wall portion 51b1 is formed to be substantially equal to the thickness of the vertical wall portion 51b2. The lateral wall portion 51b1 has a corner portion on the leading end at an opposite side of the vertical wall portion 51b2, wherein the corner portion is notched to form a diagonal portion 51b11. The diagonal portion 51b11 may ease insertion of the vertical wall portion 51b2 into the side gap 31c3 when the removal tool 50 is rotated while the handle portion 52 is grasped. The shorter side length of the vertical wall portion 51b2 and the shorter side length of the lateral wall portion 51b1 are made to be substantially equal to one side length of a quadrangular cross-section of the main body portion 51a. As shown in FIG. 6, the vertical wall portion 51b2 extends vertically with respect to the straight line DL, the straight line DL extending in a radial direction and passing through the axis center line CL of the shaft portion 51, so as to orthogonally intersect the lateral wall portion 51b1.

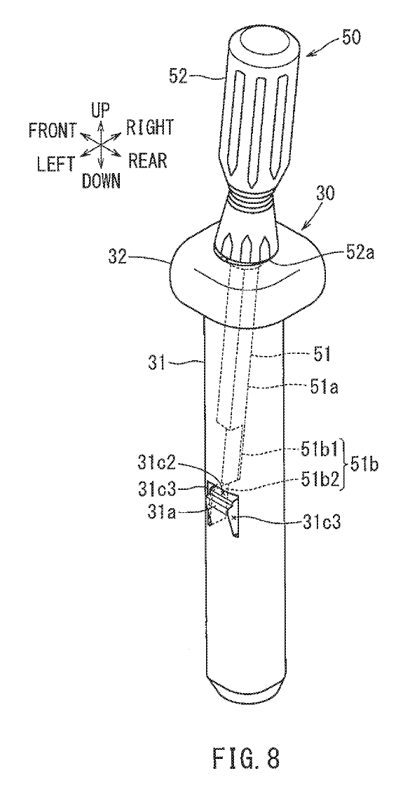

As shown in FIGS. 4 to 6, the handle portion 52 of the removal tool 50 is formed to have a diameter of two to four times as large as one side length of the quadrangular cross-section of the shaft portion 51. Its surface is provided with a plurality of grooves for slip prevention, the grooves extending parallel to an axis center line CL. As shown in FIG. 8, an end face 52a of the handle portion 52, which is on the side of the shaft portion 51, abuts an upper surface of the head portion 32 when the shaft portion 51 is inserted from the head portion 32 side of the headrest support 30 into the through hole 33. At this time, the vertical position of the vertical wall portion 51b2 is formed to be aligned with the vertical position of the side gap 31c3.

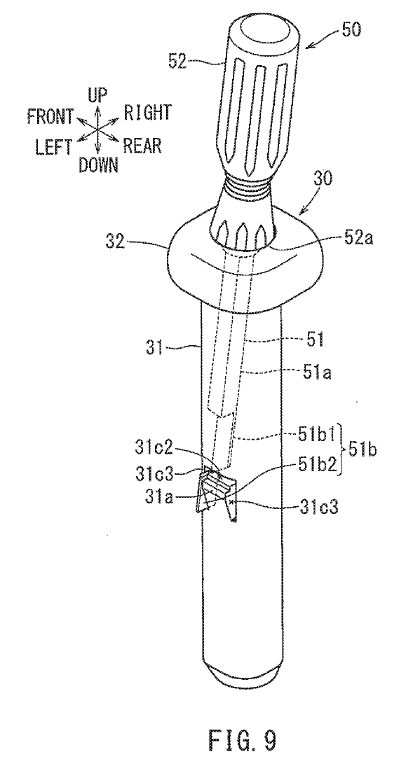

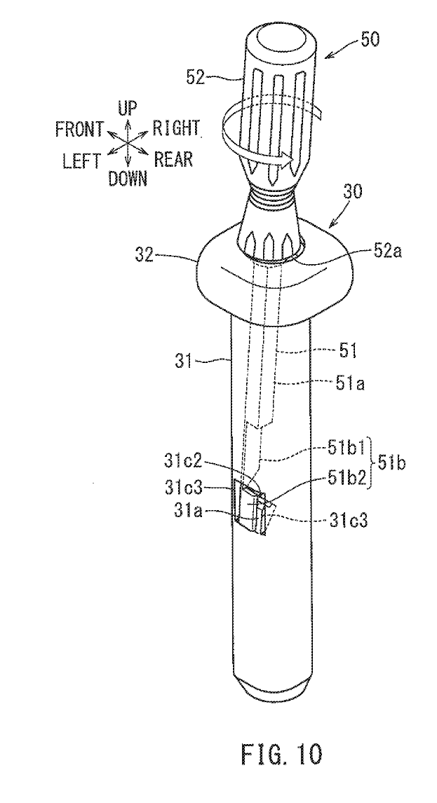

Hereinafter, procedures for removing the headrest supports 30 from the seatback 10 utilizing the removal tool 50 will be described with reference to FIGS. 7 to 10. In FIGS. 7 to 10, the holder 14 is not shown. As shown in FIG. 7, at first, the shaft portion 51 of the removal tool 50 is inserted from the side of the head portion 32 of the headrest support 30 into the through hole 33, the headrest support 30 being attached to the seatback 10. Then, as shown in FIG. 8, the end face 52a of the handle portion 52 is abutted to the upper surface of the head portion 32 of the headrest support 30. In this state, the vertical wall portion 51b2 is aligned so as to be allowed to be inserted in any one of the side gaps 31c3 of any one of the projections 31a. At this time, since an interval between the end face 52a of the removal tool 50 and the vertical wall portion 51b2 is structured to coincide with an interval between the upper surface of the head portion 32 of the headrest support 30 and the side gap 31c3, the vertical wall portion 51b2 are more easily be aligned with the side gap 31c3. Subsequently, as shown in FIG. 9, the vertical wall portion 51b2 is inserted into the side gap 31c3. Since the vertical wall portion 51b2 is positioned radially apart from the axis center line CL of the shaft portion 51 and arranged to perpendicularly extend with respect to the straight line DL extending in a radial direction, the vertical wall portion 51b2 exerts the force to deform the projection 31a such that the projection 31a is bent toward the axial center line CL when the handle portion 52 is rotated. As shown in FIG. 10, when the handle portion 52 is further rotated, the vertical wall portion 51b2 bends and deforms the projection 31a to completely insert the projection 31a into the through hole 33 so that the projection 31a disengages from the upper edge of the locking hole 14a of the holder 14. By also performing the same procedure to the other projection 31a, the headrest support 30 disengages from the holder 14 so that the headrest support 30 is allowed to be removed from the seatback 10. At this time, the projection 31a are plastically deformed so as not to return to its original state.

The exemplary embodiments according to the present invention have been described with reference to the above configuration, however, it will be apparent to those skilled in the art that various alternatives, modifications, and changes can be made without departing from the object of the present invention. Therefore, the exemplary embodiments according to the present invention may include all alternatives, modifications, and changes without departing from the gist of the invention as claimed. For example, the exemplary embodiments according the present invention shall not be limited to the specific configuration but can be changed as described below.

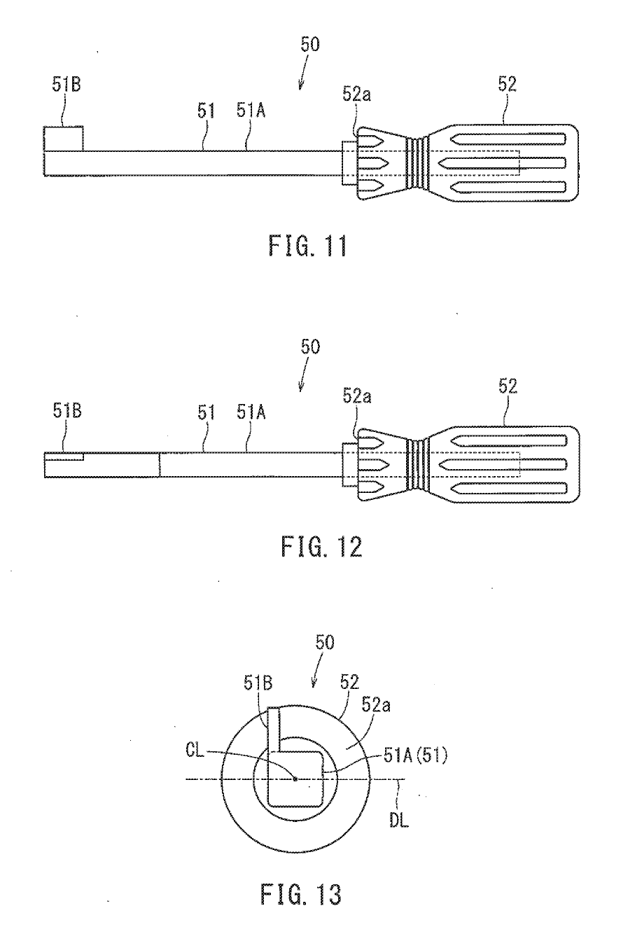

In the above exemplary embodiments, the engagement portion 51b is configured to have the lateral wall portion 51b1 and the vertical wall portion 51b2. However, it shall not be limited to this configuration and may be configured as the other exemplary embodiments as shown in FIGS. 11 to 13. Specifically, a main body portion 51A may extend up to the leading end of the shaft portion 51 and be formed with a substantially rectangular plate-like vertical wall portion 51B at the leading end. The vertical wall portion 51B extends perpendicular from a shorter edge of one surface of the shaft portion 51. The vertical wall portion 51B may have the same shape as that of the vertical wall potion 51b2. In the present exemplary embodiment, the vertical wall portion 51B is positioned radially apart from the axial center line CL of the shaft portion 51 and arranged to perpendicularly extend with respect to the straight line DL extending in a radial direction. In this way, it is possible to achieve the same effect as the removal tool 50 according to the above-described one embodiment.

In the above exemplary embodiment, the main body portion 51a of the shaft portion 51 is formed to have a quadrangular cross-section, however, it is not limited thereto, and may also have a circular or polygonal cross-section.

In the above-exemplary embodiments, the main body portion 51a of the shaft portion 51 and the engagement portion 51b are formed as one piece. However, this shall not limited thereto, and the engagement portion 51b may be attached as a replaceable socket to a main body portion. This enables it to be used as a tool for removing a headrest support by simply attaching the socket-like engagement portion 51b to an ordinary screwdriver.

In the above exemplary embodiments, the body portion 31 of the headrest support 30 is provided with the openings 31b in an opposing manner each other at the substantially vertical center of the left and right sides on the outer peripheral surface, such that the projection 31a extends upward from the lower edge 31b1 of the opening 31 so as to cover the center of the opening 31b. However, this is not limited thereto, and only one opening 31b and projection 31a may be provided on the body portion 31 of the headrest support 30.

1. A vehicle headrest support removal system, comprising:
a headrest support having a head portion, a body portion, and a through hole into which a headrest stay is inserted;
at least one opening formed on an outer peripheral surface of the body portion;
an elastically deformable projection extending upward from a lower edge of the opening, and structured to be wider toward an outer peripheral side of the body portion; and
a removal tool comprising:
a shaft portion structured to inserted into the through hole of the headrest support from the head portion side;
a handle portion fixed on the shaft portion; and
an insertion piece at an end of the shaft portion opposite to the handle portion, wherein
the insertion piece is is sized to fit between a peripheral edge of the opening and the projection, and
the insertion piece is configured to deform the projection toward an inside of the through hole when the shaft portion is rotated.

2. The vehicle headrest support removal system according to claim 1, wherein
the insertion piece is formed with a plate like shape which is positioned apart from an axis center of the shaft portion, and
the plate like shape is positioned to extend perpendicular to a line that radially extends from the axis center.

3. The vehicle headrest support removal system according to claim 1, wherein
the handle portion includes an end at the shaft portion, wherein the end is configured to abut the head portion to prevent the shaft portion from further entering the through hole while the insertion piece is positioned between the peripheral edge of the opening and the projection.

4. The vehicle headrest support removal system of according to claim 3, wherein
a length of the shaft portion from the end of the handle portion to a leading end of the shaft portion is the same as a length of the through hole between an opening in the head portion and a base of the projection.

5. A removal tool for removing a headrest support from a seatback, comprising:
a shaft portion;
a handle portion formed at a base end of the shaft portion;
an engagement portion formed at a leading end of the shaft portion, the engagement portion comprising a lateral wall portion contacting the leading end of the shaft portion and a vertical wall portion perpendicularly contacting a leading end of the lateral wall portion.

6. The removal tool for removing a headrest support from a seatback according to claim 5, wherein
the lateral wall portion and/or the vertical wall portion are positioned radially away from a central axis of the shaft portion.

7. The removal tool for removing a headrest support from a seatback according to claim 5, wherein
the shaft portion has a rectangular columnar cross-section.

8. The removal tool for removing a headrest support from a seatback according to claim 7, wherein
the lateral wall portion is aligned with a first surface of the shaft portion and the vertical wall portion is aligned with a second surface of the shaft portion, the first surface being orthogonal to the second surface.

9. The removal tool for removing a headrest support from a seatback according to claim 5, wherein
the lateral wall portion further comprises a diagonal notched portion positioned at the leading end of the lateral wall portion, the diagonal notched portion having a surface sloping towards the vertical wall portion.

10. The removal tool for removing a headrest support from a seatback according to claim 5, wherein
a width of the lateral wall portion is the same as a width of the shaft portion.

11. The removal tool for removing a headrest support from a seatback according to claim 5, wherein
a height of the vertical wall portion is the same as a height of the shaft portion.

12. The removal tool for removing a headrest support from a seatback according to claim 5, wherein
the lateral wall portion and the vertical wall portion each have a substantially plate like shape.

13. The removal tool for removing a headrest support from a seatback according to claim 12, wherein
the lateral wall portion and the vertical wall portion have the same thickness.

14. The removal tool for removing a headrest support from a seatback according to claim 5, wherein
a diameter of the handle at an end face thereof is larger than a diameter of the shaft portion at the base end, the end face being at a leading end of the handle.

15. The removal tool for removing a headrest support from a seatback according to claim 14, further comprising:
a stepped portion positioned between the end face of the handle and the base end of the shaft portion, the stepped portion having a diameter smaller than the diameter of the end face and larger than the diameter of the shaft portion.

16. A removal tool for removing a headrest support from a seatback, comprising:
a shaft portion;
a handle formed at a base end of the shaft portion; and
an engagement portion formed at and radially extending from a leading end of the shaft portion, the leading end being at an end opposite to the base end.

17. The removal tool for removing a headrest support from a seatback according to claim 16, wherein
the engagement portion is positioned radially away from an axis center of the shaft portion.

18. The removal tool for removing a headrest support from a seatback according to claim 16, wherein
a thickness of the engagement portion is thinner than a thickness of the shaft portion.

19. The removal tool for removing a headrest support from a seatback according to claim 16, wherein
the engagement portion radially extends from a first surface of the shaft portion, and
a surface of the engagement portion is aligned with a second surface of the shaft portion, the first surface being orthogonal to the second surface.

20. The removal tool for removing a headrest support from a seatback according to claim 16, wherein
a combined radius of the shaft portion and engagement portion is the same as the radius of the handle portion.
